(19) United States
(12) Patent Application Publication
(10) Pub. No.: US 2010/0204439 A1
(43) Pub. Date: Aug. 12, 2010

(54) PROCESSES FOR MAKING POLY(TRIMETHYLENE ETHER) GLYCOL USING ORGANOPHOSPHOROUS COMPOUND

(75) Inventors: Yanhui Niu, Newark, DE (US); Zuohong Yin, West Chester, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/367,575

(22) Filed: Feb. 9, 2009

(51) Int. Cl. C08G 65/46

(52) U.S. Cl. 528/425

(57) ABSTRACT

Processes for preparing poly(trimethylene ether)glycol-based polymers using an organophosphorous compound are provided.

### FIELD OF THE INVENTION

The present invention relates to processes for preparing poly(trimethylene ether)glycol-based polymers using an organophosphorous compound. The poly(trimethylene ether)glycol-based polymers prepared by the processes desirably have lower color than those prepared using conventional methods.

### BACKGROUND

Poly(trimethylene ether)glycol (poly(trimethylene ether)glycol) and its uses have been described in the art. Some methods for preparation of a poly(trimethylene ether)glycol involve acid catalyzed polycondensation of 1,3-propanediol. One commonly used acid catalyst is sulfuric acid.

Catalyst systems including an acid and base have been used to produce polyether polyol with a high degree of polymerization and low color under mild conditions, such as wherein the base is sodium carbonate, (US Patent Publications Nos. 2005/0272911A1 and 2007/0203371 A1).

In some known poly(trimethylene ether)glycol polymer manufacturing processes, the poly(trimethylene ether)glycol polymers have residual color that results into a lower-quality polymer, not adequate for many of the polymer applications. The color of the polymer can be affected by factors such as temperature of polymerization and oxidizing agents present in the reaction mixture, acidity.

The presence of color is undesirable in polytrimethylene glycol polymers for some applications. Because conventional poly(trimethylene ether)glycol processes can involve high-temperature processing, discoloration can happen in various steps in a process, especially with a strong oxidizing agent (such as H₂SO₄) present in the mixture.

### SUMMARY OF THE INVENTION

One aspect of the present invention is a process for manufacturing a poly(trimethylene ether)glycol, comprising:

(a) polycondensing reactant comprising a diol selected from the group consisting of 1,3-propanediol, 1,3-propanediol dimer, 1,3-propanediol trimer and mixtures thereof, in the presence of an acid polycondensation catalyst to form a poly(trimethylene ether)glycol and an acid ester of the acid polycondensation catalyst;

(b) adding water to the poly(trimethylene ether)glycol and hydrolyzing the acid ester formed during the polycondensation to form a hydrolyzed aqueous-organic mixture containing poly(trimethylene ether) glycol and residual acid polycondensation catalyst;

(c) forming an aqueous phase and an organic phase from the hydrolyzed aqueous-organic mixture, wherein the organic phase contains poly(trimethylene ether)glycol, residual water and residual acid polycondensation catalyst,

(d) separating the aqueous phase and the organic phase;

(e) optionally adding base to the separated organic phase;

(f) removing residual water from the organic phase; and

(g) if no base has been added to the separated organic phase, optionally separating the organic phase into (i) a liquid phase comprising poly(trimethylene ether)glycol, and (ii) a solid phase comprising salts of the residual acid polycondensation catalyst and unreacted base, and if base has been added to the separated organic phase, separating the organic phase into (i) a liquid phase comprising poly(trimethylene ether) glycol, and (ii) a solid phase comprising salts of the residual acid polycondensation catalyst and unreacted base; the process comprising adding DOPO at least once during at least one of the steps (b), (c), (d), (e),(f), and (g), such that the total amount of DOPO is from about 0.01 wt % to about 5 wt %.

### DETAILED DESCRIPTION

The present invention provides processes for making poly(trimethylene ether)glycol. In some embodiments, the process provides shorter cycle times and/or lower cost, as compared to conventional processes.

In preferred embodiments, the process produces the poly(trimethylene ether)glycol without substantially compromising polymer properties, by using an organophosphorous compound, 9,10-dihydro-9-oxa-10-phosphaphenanthrene-10-oxide, also known as DOPO.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

The materials, methods, and examples herein are illustrative only and, except as specifically stated, are not intended to be limiting. Although methods and materials similar or equivalent to those described herein can be used in the practice or testing of the present invention, suitable methods and materials are described herein.

The processes disclosed herein use a reactant comprising at least one of 1,3-propanediol, 1,3-propanediol dimer and 1,3-propanediol trimer. In some embodiments, the reactant comprises mixtures of 1,3-propanediol, 1,3-propanediol dimer and 1,3-propanediol trimer. The reactant is referred to herein as “1,3-propanediol reactant”. The 1,3-propanediol reactant can be obtained by any of the various known chemical routes or by known biochemical transformation routes.

A preferred source of 1,3-propanediol is via a fermentation process using a renewable biological source. As an illustrative example of a reactant from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The thus-produced biologically-derived 1,3-propanediol contains carbon from the atmospheric carbon dioxide incorporated by plants, which compose the feedstock for the production of the 1,3-propanediol. In this way, the preferred biologically-derived 1,3-propanediol contains only renewable carbon, and not fossil fuel-based or petroleum-based carbon.

The biologically-derived 1,3-propanediol, and poly(trimethylene ether)glycols, may be distinguished from similar compounds produced from a petrochemical source or from fossil fuel carbon by dual carbon-isotopic finger printing. This method usefully distinguishes chemically-identical materials, and apportions carbon in the copolymer by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles. J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship

t=(−5730/0.693)ln(A/A₀)

where t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphoenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ⁰/₀₀, and are calculated as follows:

$${δ}^{13} C ≡ \frac{{(}^{13} C {/}^{12} C ) sample - {(}^{13} C {/}^{12} C ) standard}{{(}^{13} C {/}^{12} C ) standard} \times 1000 \% o$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as the reactant or as a component of the reactant has a purity of greater than about 99%, and more preferably greater than about 99.9%, by weight, as determined by gas chromatographic analysis.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having CIELAB L*a*b* “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

The starting materials used for making the poly(trimethylene ether) glycol are selected based on factors including the desired poly(trimethylene ether)glycol, availability of reactants, catalysts, equipment, etc., and comprises “1,3-propanediol reactant.” By “1,3-propanediol reactant” is meant 1,3-propanediol, and oligomers and prepolymers of 1,3-propanediol preferably having a degree of polymerization of 2 to 9, and mixtures thereof. In some instances, it may be desirable to use up to 10% or more of low molecular weight oligomers where they are available. Thus, preferably the reactant comprises 1,3-propanediol and the dimer and trimer thereof. A particularly preferred reactant is comprised of about 90% by weight or more 1,3-propanediol, and more preferably 99% by weight or more 1 ,3-propanediol, based on the weight of the 1,3-propanediol reactant.

The reactant may also contain small amounts, preferably no more than about 30%, and more preferably no more than about 10%, by weight, of the reactant, of comonomer diols in addition to the reactant 1,3-propanediol or its dimers and trimers without detracting from the efficacy of the process. Examples of preferred comonomer diols include ethylene glycol, 2-methyl-1,3-propanediol, 2,2-dimethyl-1,3 propanediol, and C₆-C₁₂ diols such as 2,2-diethyl-1,3-propanediol, 2-ethyl-2-hydroxymethyl-1,3-propanediol, 1,6-hexanediol, 1,8-octanediol, 1,10-decanediol, 1,12-dodecanediol, 1,4-cyclohexanediol and 1,4-cyclohexanedimethanol. A more preferred comonomer diol is ethylene glycol. The poly(trimethylene ether)glycols of this invention can also be prepared using from about 10 to about 0.1 mole percent of an aliphatic or aromatic diacid or diester, preferably terephthalic acid or dimethyl terephthalate, and most preferably terephthalic acid.

Stabilizers (e.g., UV stabilizers, thermal stabilizers, antioxidants, corrosion inhibitors, etc.), viscosity boosters, antimicrobial additives and coloring materials (e.g., dyes, pigments, etc.) may be added to the polymerization mixture or product if necessary, as can be determined by one skilled in the art.

Any acid catalyst suitable for acid catalyzed polycondensation of 1,3-propanediol may be used in the present process. The polycondensation catalysts are preferably selected from the group consisting of Lewis acids, Bronsted acids, super acids and mixtures thereof, and they include both homogeneous and heterogeneous catalysts. More preferably, the catalysts are selected from the group consisting of inorganic acids, organic sulfonic acids, heteropolyacids and metal salts. Still more preferably, the catalyst is a homogeneous catalyst, preferably selected from the group consisting of sulfuric acid, hydriodic acid, fluorosulfonic acid, phosphorous acid, p-toluenesulfonic acid, benzenesulfonic acid, methanesulfonic acid, phosphotungstic acid, trifluoromethanesulfonic acid, phosphomolybdic acid, 1,1,2,2-tetrafluoro-ethanesulfonic acid, 1,1,1,2,3,3-hexafluoropropanesulfonic acid, bismuth triflate, yttrium triflate, ytterbium triflate, neodymium triflate, lanthanum triflate, scandium triflate and zirconium triflate. The catalyst can also be a heterogeneous catalyst, preferably selected from the group consisting of zeolites, fluorinated alumina, acid-treated alumina, heteropolyacids and heteropolyacids supported on zirconia, titania alumina and/or silica. An especially preferred catalyst is sulfuric acid.

Preferably, the polycondensation catalyst is used in an amount of from about 0.1 wt % to about 3 wt %, more preferably from about 0.5 wt % to about 1.5 wt %, based on the weight of reactant.

The process can be carried out using a base or a salt as a component of the catalyst system, such as a polycondensation catalyst that contains both an acid and a base. When base is used as a component of the polycondensation catalyst, the base is used in an amount insufficient to neutralize all of the acid present in the catalyst.

Optional additives can be present during the polycondensation, for example, an inorganic compound such as an alkali metal carbonate, and an onium compound.

Preferred inorganic compounds are alkali metal carbonates, more preferably selected from potassium carbonate and/or sodium carbonate, and still more preferably sodium carbonate.

By onium compound is meant a salt which has onium ion as the counter cation. Generally, the onium salt has a cation (with its counterion) derived by addition of a hydron to a mononuclear parent hydride of the nitrogen, chalcogen and halogen family, e.g. H₄N⁺ ammonium ion. It also includes Cl₂F⁺ dichlorofluoronium, (CH₃)₂S⁺H dimethylsulfonium (a secondary sulfonium ion), ClCH₃)₃P⁺ chlorotrimethylphosphonium, (CH₃CH₂)₄N⁺ tetraethylammonium (a quaternary ammonium ion). Preferred are quaternary ammonium compounds, phosphonium compounds, arsonium compounds, stibonium compounds, oxonium ions, sulfonium compounds and halonium ions. Preferred compounds also include derivatives formed by substitution of the parent ions by univalent groups, e.g. (CH₃)₂S⁺H dimethylsulfonium, and (CH₃CH₂)₄N⁺ tetraethylammonium. Onium compounds also include derivatives formed by substitution of the parent ions by groups having two or three free valencies on the same atom. Such derivatives are, whenever possible, designated by a specific class name, e.g. RC═O⁺ hydrocarbylidyne oxonium ions R₂C═NH₂⁺ iminium ion, RC≡NH⁺ nitrilium ions. Other examples include carbenium ion and carbonium ion. Preferred onium compounds also include Bu₄N⁺HSO₄⁻, (Me₄N)₂⁺SO₄²⁻, Py⁺Cl⁻, Py⁺OH⁻, Py⁺(CH²)¹⁵CH³Cl⁻, Bu₄P⁺Cl⁻ and Ph₄⁺PCl⁻.

An organophosphorous compound is added in at least one step during polymerization or preparation of the poly(trimethylene ether)glycol polymer to remove and/or reduce the color of the resulting product.

One particularly useful organophosphorous compound is 9,10-dihydro-9-oxa-10-phosphaphenanthrene-10-oxide, also known as DOPO, and available from Sanko Chemical Co. Ltd., Hiroshima, Japan.

Preferably, the organophosphorous compound is used in an amount in the range of from about 0.01 wt % to about 5 wt %, more preferably from about 0.03 wt % to about 2 wt %, based on the weight of reactant. The compound can be added in one or more steps of the process, with the total weight percent added being within these values.

The polymerization process can be batch, semi-continuous, or continuous. In a batch process the polytrimethylene-ether glycol is prepared by a process comprising the steps of: (a) providing (1) reactant, and (2) acid polycondensation catalyst; and (b) polycondensing the reactants to form a poly(trimethylene ether)glycol. The reaction is conducted at an elevated temperature of at least about 150° C., more preferably at least about 160° C., up to about 210° C., more preferably about 200° C. The reaction is preferably conducted either at atmospheric pressure in the presence of inert gas or at reduced pressure (i.e., less than 760 mm Hg), preferably less than about 500 mm Hg in an inert atmosphere, and extremely low pressures can be used (e.g., as low as about 1 mm Hg or 133.3×10⁻⁶ MPa).

A preferred continuous process for preparation of the poly(trimethylene ether)glycols of the present invention comprises: (a) continuously providing (i) reactant, and (ii) polycondensation catalyst; and (b) continuously polycondensing the reactant to form poly(trimethylene ether)glycol.

Regardless of whether the process is a continuous or batch process, or otherwise, a substantial amount of acid ester is formed from reaction of the catalyst with the hydroxyl compounds, particularly when a homogeneous acid catalyst (and most particularly sulfuric acid) is used. In the case of sulfuric acid, a substantial portion of the acid is converted to the ester, alkyl hydrogen sulfate. It is desirable to remove these acid esters because, for example, they can act as emulsifying agents during the water washing used to remove catalyst and therefore cause the washing process to be difficult and time consuming The removal can be carried out by hydrolyzing the acid esters formed during the polycondensation that are in the aqueous-organic mixture. The hydrolysis step is preferably carried out by adding water to the polymer. The amount of water added can vary and is preferably from about 10 to about 200 wt %, more preferably from about 50 to about 100 wt %, based on the weight of the poly(trimethylene ether)glycol. Hydrolysis preferably includes heating the aqueous-organic mixture to a temperature in the range from about 50 to about 110° C., more preferably from about 90 to about 110° C. (and more preferably from about 90 to about 100° C. for a period of sufficient time to hydrolyze the acid esters. Hydrolysis also functions in the process to form polymer with an adequately high dihydroxy functionality that the polymer can be used as a reactive intermediate. Furthermore, the hydrolysis step can also help to increase the yield of the process.

The hydrolysis step is preferably conducted at atmospheric or slightly above atmospheric pressure, preferably at about 700 mmHg to about 1600 mmHg. Higher pressures can be used, but are not preferred. The hydrolysis step is carried out preferably under inert gas atmosphere.

The process further includes forming and separating the water phase and the organic phase. Phase formation and separation is preferably promoted by either adding an inorganic compound such as a base and/or salt, or by adding an organic solvent to the reaction mixture.

There are several processes for preparing poly(trimethylene ether)glycol by acid polycondensation wherein the phase separation after hydrolysis is promoted by addition of organic solvent miscible with poly(trimethylene ether)glycol, or is miscible with water. Generally, the solvents used in these processes may be used conjunction with water-soluble inorganic compounds to promote phase separation. Preferred is the use of the water-soluble inorganic compounds, which are added to the aqueous poly(trimethylene ether)glycol mixture after hydrolysis.

Preferred water-soluble, inorganic compounds are inorganic salts and/or inorganic bases. Preferred salts are those comprising a cation selected from the group consisting of ammonium ion, Group IA metal cations, Group IIA metal cations and Group IIIA metal cations, and an anion selected from the group consisting of fluoride, chloride, bromide, iodide, carbonate, bicarbonate, sulfate, bisulfate, phosphate, hydrogen phosphate, and dihydrogen phosphate (preferably chloride, carbonate and bicarbonate). Group IA cations are lithium, sodium, potassium, rubidium, cesium and francium cations (preferably lithium, sodium and potassium); Group IIA cations are beryllium, magnesium, calcium, strontium, barium and radium (preferably magnesium and calcium); and Group IIIA cations are aluminum, gallium, indium and thallium cations. More preferred salts for the purposes of the invention are alkali metal, alkaline earth metal and ammonium chlorides such as ammonium chloride, lithium chloride, sodium chloride, potassium chloride, magnesium chloride, calcium chloride; and alkali metal and alkaline earth metal carbonates and bicarbonates such as sodium carbonate and sodium bicarbonate. The most preferred salts are sodium chloride; and alkali metal carbonates such as sodium and potassium carbonate, and particularly sodium carbonate.

Typical inorganic bases for use in the invention are ammonium hydroxide and water-soluble hydroxides derived from any of the above-mentioned Group IA, IIA and IIIA metal cations. The most preferred water-soluble inorganic bases are sodium hydroxide and potassium hydroxide.

The amount of water-soluble, inorganic compound used may vary, but is preferably the amount effective in promoting the rapid separation of the water and inorganic phases. The preferred amount for this purpose is from about 1 to about 20 wt %, more preferred amount from about 1 to about 10 wt %, and still more preferably from about 2 to about 8 wt %, based on the weight of the water added to the poly(trimethylene ether)glycol in the hydrolysis step.

Preferably the time required for phase separation is less than about one hour. More preferably this time period is from less than about 1 minute to about one hour, and most preferably about 30 minutes or less.

Separation is preferably carried out by allowing the water phase and the organic phase to separate and settle so that the water phase can be removed. The reaction mixture is allowed to stand, preferably without agitation until settling and phase separation has occurred.

Once phase separation has occurred, the water phase and the organic phase can be physically separated from each other, preferably by decantation or draining. It is advantageous to retain the organic phase in the reactor for subsequent processing. Consequently, when the organic phase is on the bottom of the reactor it is preferred to decant off the aqueous phase and when the organic phase is on the top of the reactor, it is preferred to drain off the aqueous phase.

A preferred phase separation method when high molecular weight polymer is obtained is gravity separation of the phases.

Following the hydrolysis and phase separation, a base, preferably a substantially water-insoluble base, may be added to neutralize any remaining acid. During this step residual acid polycondensation catalyst is converted into its corresponding salts. However, the neutralization step is optional.

Preferably, the base is selected from the group consisting of alkaline earth metal hydroxides and alkaline earth metal oxides. More preferably, the base is selected from the group consisting of calcium hydroxide, calcium oxide, magnesium hydroxide, magnesium oxide, barium oxide and barium hydroxide. Mixtures may be used. A particularly preferred base is calcium hydroxide. The base may be added as a dry solid, or preferably as an aqueous slurry. The amount of insoluble base utilized in the neutralization step is preferably at least enough to neutralize all of the acid polycondensation catalyst. More preferably a stoichiometric excess of from about 0.1 wt % to about 10 wt % is utilized. The neutralization is preferably carried out at 50 to 90° C. for a period of from 0.1 to 3 hours under nitrogen atmosphere.

Following the hydrolysis and phase separation and optional neutralization, organic solvent used in the process and any residual water is preferably removed from the organic phase by vacuum stripping (e.g., distillation at low pressure), generally with heating, which will also remove organic solvent if present and, if desired, unreacted monomeric materials. Other techniques can be used, such as distillation at about atmospheric pressure.

When base is added for neutralization, and residual acid catalyst salts are formed, the organic phase is separated into (i) a liquid phase comprising the poly(trimethylene ether)glycol, and (ii) a solid phase comprising the salts of the residual acid polycondensation catalyst and unreacted base. This separaton can optionally be carried out even if base has not been added for neutralization. Typically, the separation is carried out by filtration, or centrifugation, to remove the base and the acid/base reaction products. Centrifugation and filtration methods are generally well known in the art. For example, gravity filtration, centrifugal filtration, or pressure filtration can be used. Filter presses, candle filters, pressure leaf filters or conventional filter papers are also be used for the filtration, which can be carried out batch wise or continuously. Filtration in the presence of a filter-aid is preferred at a temperature range from 50 to 100° C. at a pressure range from 0.1 MPa to 0.5 MPa.

Even if base is not added for neutralization, purification techniques like centrifugation and filtration may still be desirable for refining the final product.

An organophosphorous compound is added at least once during at least one of the steps in the process set forth hereinabove. It may be advantageous, for greater color reduction, to add an organophosphorous compound when adding water to the poly(trimethylene ether)glycol and hydrolyzing the acid ester formed during the polycondensation to form a hydrolyzed aqueous-organic mixture containing poly(trimethylene ether)glycol and residual acid polycondensation catalyst, or when forming an aqueous phase and an organic phase from the hydrolyzed aqueous-organic mixture, wherein the organic phase contains poly(trimethylene ether)glycol, residual water and residual acid polycondensation catalyst, rather than later in the process.

Generally, when poly(trimethylene ether)glycol is made according to the processes disclosed herein, the product color is reduced by at least 5% based on APHA value, and more usually is reduced by at least 20% based on APHA value, and can be reduced by as much as 30% , and in some embodiments, by 65% or more, based on APHA value as compared to the color obtained if the process is carried out in the absence of the organophosphorous compound. Also, the product is produced with greatly reduced phase separation time, generally from over 10 hours in the absence of the organophosphorous compound, to about 30 minutes. Also, the organophosphorous compound can be combined with other color-reducing materials known to those skilled in the art, including but not limited to carbon black and zero-valent metals that generally do not react with the organophosphorous compound.

The organophosphorous compound used can be of any convenient particle size. It can be added in more than one step of the process as described herein. It may be added in any convenient way, and while it can be added with agitation, it is not generally necessary to do so.

The processes disclosed herein are not limited to the addition of the DOPO as the sole purification/color reduction technique, but the use of DOPO can be combined with other well-known techniques as known to those skilled in the art.

For some applications, the poly(trimethylene ether)glycols made by the processes disclosed herein herein preferably have a number average molecular weight from about 250 to about 7000, preferably from about 250 to about 5000. Mn of 500 to 5000 is preferred for many applications. Mn of 1000 to 3000 is further preferred. The poly(trimethylene ether) are typically polydisperse polymers having a polydispersity of preferably from about 1.0 to about 2.2, more preferably from about 1.2 to about 2.0, and still more preferably from about 1.2 to about 1.8.

The poly(trimethylene ether)glycols preferably have a color reduction of great than about 10%, more preferably greater than about 30%, as compared with the process where DOPO is not used.

The poly(trimethylene ether)glycols preferably have a color value of less than about 100 APHA, and more preferably less than about 40 APHA.

The invention is illustrated in the following examples. All parts, percentages, etc., referred to in the examples are by weight unless otherwise indicated.

### EXAMPLES

The examples utilized either a chemical 1,3-propane diol (“chem-PDO”) or a biologically-derived 1,3-propane diol (“bio-PDO”). The bio-PDO had a purity of higher than 99.99%.

Unless otherwise specified, all chemicals and reagents (including filter aids) were used as received from Sigma-Aldrich, St. Louis, Mo.

### Comparative Example 1

### No DOPO Added

1,3-propanediol (Chem-PDO, 602.02 g) and Na₂CO₃ (0.81 g) were charged into a 1 L glass flask and then heated to 170±1° C. under nitrogen with overhead stirring. Then 8.26 g of sulfuric acid was injected to the reaction flask and continue to heat at 170±1° C. for 12 hrs to produce poly(trimethylene ether)glycol. During the reaction, by-product water was removed with a condenser.

The resulting polymeric product was called the “crude” polymer for examples 1 and 2.

Crude poly(trimethylene ether)glycol product (100 g) and equal amount of deionized (DI) water (100 g) were charged into a 500 mL batch reactor and mixed by overhead stirring at 120 rpm, and under nitrogen blanketing. The polymer-water mixture was heated to 95° C. and held at that temperature for 3 hrs.

Subsequently, the mixture was cooled to about 70° C. and the aqueous-rich portion was removed.

The polymer-rich portion was further hydrolyzed, upon addition of another 100 g of DI water, for one hr, under the same condition at 95° C. to complete the hydrolysis step.

A clear visible separation was observed after half an hour. The aqueous phase was removed upon phase separation. The remainder poly(trimethylene ether)glycol-rich phase was neutralized with 0.5 g of Ca(OH)₂ (0.5% wt/wt of crude polymer) at 70° C. for 2 hrs. The mixture was subsequently dried at about 85° C., under 10 torr (1 torr=133.32×10⁻⁶ MPa) pressure, for 2 hrs. The dried mixture was filtered with filter aid (Celpure® C65) at 80° C. (Steam Temp.).

The APHA number was calculated from absorbance data collected every 5 nm from 780 nm to 380 nm. Absorbance data were converted to transmittance. A calibration of APHA vs. Yellowness index was performed using PtCo standards ranging from APHA 15 to 500 according to the ASTM standard 5386-93b. The APHA color number of the poly(trimethylene ether)glycol was found to be at 69.41.

### Example 2

### DOPO Added During Hydrolysis

Crude poly(trimethylene ether)glycol product (50 g) made as described in Example 1 above, and an equal amount of DI water (50 g) were charged into a 500 mL batch reactor and mixed by overhead stirring at 120 rpm, and under nitrogen blanketing. The polymer-water mixture was heated to 95° C. and held at that temperature for 30 min. Subsequently, 0.5 g or 1% of DOPO was added to the mixture, and the mixture was further heated for 2.5 hrs.

Subsequently, the mixture was cooled to about 70° C. and the aqueous-rich portion was removed.

The polymer-rich portion was further hydrolyzed, upon addition of another 50 g of DI water, for one hour, under the same condition at 95° C. to complete the hydrolysis step.

A clear visible phase separation was observed after 5 min. The aqueous phase was removed upon phase separation. The remainder poly(trimethylene ether)glycol-rich phase was neutralized with 0.25 g of Ca(OH)₂ (0.5% wt/wt of crude polymer) at 70° C. for 2 hrs. The mixture was subsequently dried at about 85° C., under 6 torr (1 torr=133.32×10⁻⁶ MPa) pressure, for 2 hrs. The dried mixture was filtered with filter aid (Celpure® C65) at 80° C. (Steam Temp.). The APHA color number of the poly(trimethylene ether)glycol was found to be at 24.55.

### Comparative Example 3

### No DOPO Added

1,3-propanediol (chem-PDO, 3010 g) and Na₂CO₃ (4.05 g) were charged into a 5 L glass flask and then heated to 170±1° C. under nitrogen with overhead stirring. Then 41.3 g of sulfuric acid was injected to the reaction flask and heating was continued at 170±1° C. for 12 hrs to produce polytrimethylene ether glycol. During the reaction, by-product water was removed with a condenser.

The resulting product is referred to as the “Crude poly(trimethylene ether)glycol” for examples 5-6.

Crude poly(trimethylene ether)glycol Product 1 (50 g) and equal amount of DI water (50 g) were charged into a 250 mL batch reactor and mixed by overhead stirring at 120 rpm, and under nitrogen blanketing. The polymer-water mixture was heated to 95° C. and held at that temperature for 3 hrs.

Subsequently, the mixture was cooled to about 70° C. and the aqueous-rich portion was removed.

The polymer-rich portion was further hydrolyzed, upon addition of another 50 g of DI water, for one hr, under the same conditions at 95° C. to complete the hydrolysis step.

The aqueous phase was removed upon phase separation. The remainder polymer-rich phase was neutralized with 0.25 g of Ca(OH)₂ (0.5% wt/wt of crude polymer) at 70° C. for 2 hrs. The mixture was subsequently dried at about 85° C., under 6 torr (1 torr=133.32×10⁻⁶ MPa) pressure, for 2 hrs. The dried mixture was filtered with filter aid (Celpure® C65) at 80° C. (Steam Temp.).

The APHA number was calculated from absorbance data collected every 5 nm from 780 nm to 380 nm. Absorbance data were converted to transmittance. A calibration of APHA vs. Yellowness index was performed using PtCo standards ranging from APHA 15 to 500 according to the ASTM standard 5386-93b. The APHA color number of the poly(trimethylene ether)glycol was found to be at 278.6.

### Example 4

### DOPO Added During Drying

1,3-propanediol (chem-PDO, 3010 g) and Na₂CO₃ (4.05 g) were charged into a 5 L glass flask and then heated to 170±1° C. under nitrogen with overhead stirring. Then 41.3 g of sulfuric acid was injected to the reaction flask and heating was continued at 170±1° C. for 12 hrs to produce polytrimethylene ether glycol. During the reaction, by-product water was removed with a condenser.

The resulting product is referred to as the “Crude poly(trimethylene ether)glycol” for examples 5-6.

Crude poly(trimethylene ether)glycol Product 1 (50 g) and equal amount of DI water (50 g) were charged into a 250 mL batch reactor and mixed by overhead stirring at 120 rpm, and under nitrogen blanketing. The polymer-water mixture was heated to 95° C. and held at that temperature for 3 hrs.

Subsequently, the mixture was cooled to about 70° C. and the aqueous-rich portion was removed.

The polymer-rich portion was further hydrolyzed, upon addition of another 50 g of DI water, for one hr, under the same conditions at 95° C. to complete the hydrolysis step.

The aqueous phase was removed upon phase separation. The remainder polymer-rich phase was neutralized with 0.25 g of Ca(OH)₂ (0.5% wt/wt of crude polymer) at 70° C. for 2 hrs. The mixture was subsequently added with 0.5 g of DOPO and dried at about 85° C., under 6 torr (1 torr=133.32×10⁻⁶ MPa) pressure, for 2 hrs. The dried mixture was filtered with filter aid (Celpure® C65) at 80° C. (Steam Temp.).

The APHA number was calculated from absorbance data collected every 5 nm from 780 nm to 380 nm. Absorbance data were converted to transmittance. A calibration of APHA vs. Yellowness index was performed using PtCo standards ranging from APHA 15 to 500 according to the ASTM standard 5386-93b. The APHA color number of the poly(trimethylene ether)glycol was found to be at 262.5.

### Comparative Example 5

### No DOPO Added

1,3-propanediol (Bio-PDO, 3000 lb) and Na₂CO₃ (1.5 lb) were charged into the reactor and then heated to 167±1° C. under nitrogen with overhead stirring. Then 29 lb of sulfuric acid was injected to the reaction flask and continue to heat at 167±1° C. for 16.75 hrs to produce poly(trimethylene ether)glycol. During the reaction, by-product water was removed with a condenser. The resulting polymeric product was called the “crude” polymer.

The crude poly(trimethylene ether)glycol polymer was charged with DI water (1000 lb) and mixed by overhead stirring at 100 rpm, and under nitrogen blanketing. The polymer-water mixture was heated to 95° C. and held at that temperature for 11 hrs.

Subsequently, the mixture was charged with Na₂CO₃ (33 lb) at 90-95° C. and stirred at 100 rpm for 1 hr.

The aqueous phase was removed upon phase separation at 80° C. without stirring. The remainder poly(trimethylene ether)glycol-rich phase was subsequently dried at about 100° C. and 100 rpm stirring, under 20-50 torr Hg (1 torr=133.32×10⁻⁶ MPa) pressure, for 9 hrs. The dried mixture was filtered with filter aid (Solka-Floc® 40) at 100° C. and 30 psi pressure. The dried poly(trimethylene ether)glycol product was used for examples 7 and 8.

The dried poly(trimethylene ether)glycol product (75 g), and 1.5 g or 2% of DI-water were stirred at RT for 33 min. The mixture was then pumped dry at 80° C., under the pressure of 300 militorr (1 torr=133.32×10⁻⁶ MPa) pressure, for 4 hrs. The dried mixture was filtered with filter aid (Solka-Floc®) at RT. The filtered product was filtered again with the filter aid of Celpure® (90% at the bottom and Solka-Floc® (10%) at the top. The APHA color was found to be at 52.0.

### Example 6

### 1% DOPO Added after Drying

The dried poly(trimethylene ether)glycol product (75 g) as prepared in Example 3 above, and 1.5 g or 2% of DI-water were stirred at RT for 3 min. The mixture was then added with 1% DOPO (0.75 g) and stirred at 80° C. for 30 minutes. The mixture was pumped dry at 80° C., under the pressure of 300 militorr (1 torr=133.32×10⁻⁶ MPa) pressure, for 4 hrs. The dried mixture was filtered with filter aid (Solka-Floc®) at RT. The filtered product was filtered again with the filter aid of Celpure® (90% at the bottom and Solka-Floc® (10%) at the top. The APHA color was found to be at 28.2.

### Comparative Example 7

### No DOPO Added

1,3-propanediol (Bio-PDO, 3000 lb) and Na₂CO₃ (1.5 lb) were charged into the reactor and then heated to 165±1° C. under nitrogen with overhead stirring. Then 29 lb of sulfuric acid was injected to the reaction flask and continue to heat at 165±1° C. for 29.5 hrs to produce poly(trimethylene ether)glycol. During the reaction, by-product water was removed with a condenser. The resulting polymeric product was called the “crude” polymer.

The crude poly(trimethylene ether)glycol polymer was charged with DI water (1000 lb) and mixed by overhead stirring at 100 rpm, and under nitrogen blanketing. The polymer-water mixture was heated to 95° C. and held at that temperature for 7 hrs.

Subsequently, the mixture was charged with Na₂CO₃ (45 lb) at 90-95° C. and stirred at 100 rpm for 1 hr.

The aqueous phase was removed upon phase separation at 80° C. without stirring. The remainder poly(trimethylene ether)glycol-rich phase was subsequently dried at about 100° C. and 100 rpm stirring, under 20-50 torr Hg (1 torr=133.32×10⁻⁶ MPa) pressure, for 6 hrs. The dried mixture was filtered with filter aid (Solka-floc® 40) at 100° C. and 30 psi pressure. The dried poly(trimethylene ether)glycol product was used for examples 9 and 6.

The dried poly(trimethylene ether)glycol product (75 g) and 1.5 g or 2% of DI-water were added to a round bottom flask and stirred at 80° C. for 34 minutes. The mixture was then pumped dry at 80° C., under the pressure of 300 militorr (1 torr=133.32×10⁻⁶ MPa) pressure, for 4 hrs. The dried mixture was filtered with filter aid (Solka-Floc®) at RT. The APHA color was found to be at 82.6.

### Example 8

### 1% DOPO Added After Drying

The dried poly(trimethylene ether)glycol product (75 g), 1.5 g or 2% of DI-water and 1% DOPO (0.75 g) were added to a round bottom flask and stirred at 80° C. for 34 minutes. The mixture was then pumped dry at 80° C., under the pressure of 300 militorr (1 torr=133.32×10⁻⁶ MPa) pressure, for 4 hrs. The dried mixture was filtered with filter aid (Solka-Floc®) at RT. The APHA color was found to be at 56.5.

### Comparative Example 9

1,3-propanediol (Bio-PDO, 3700 g) was charged into a 5 L glass flask and then heated to 166±1° C. under nitrogen with overhead stirring. Then 35.05 g of sulfuric acid was injected to the reaction flask and continue to heat at 166±1° C. for 28 hrs to produce poly(trimethylene ether)glycol. During the reaction, by-product water was removed with a condenser. The resulting polymeric product was called the “crude” polymer.

The crude poly(trimethylene ether)glycol polymer (1000 g) and 500 g of DI water (50 g) were charged into a 2 L batch reactor and mixed by overhead stirring at 120 rpm, and under nitrogen blanketing. The polymer-water mixture was heated to 95° C. and held at that temperature for 6 hrs. The mixture was then cooled to about 55° C.

Subsequently, the mixture (polymer and water) was added with 4% Na₂CO₃ (by weight of H₂O) while sample is at 60° C. and stirred for 30 minutes. The mixture was allowed to separate overnight. Then the aqueous-rich portion was removed. The polymer rich portion was used for examples 11 and 12.

The polymer-rich portion (25 g) was then transferred to a vial and place into oil bath at 60° C. for 30 minutes while stirring with magnetic stirring bar. The mixture was subsequently transferred to a round bottom flask and pumped dry at about 85° C., under 6 torr (1 torr=133.32×10⁻⁶ MPa) pressure, for 1.5 hrs. The dried mixture was filtered with a syringe filter (0.2 um). The APHA color number of the poly(trimethylene ether) glycol was found to be at 45.

### Example 10

### 1% DOPO Added After Phase Separation

The polymer-rich portion (25 g) was then transferred to a vial and place into oil bath at 60° C. Then DOPO (0.25 g) was added to the mixture. The mixture was subsequently heated at 60° C. for 30 minutes while stirring with magnetic stirring bar. The mixture was subsequently transferred to a round bottom flask and pumped dry at about 85° C., under 6 torr (1 torr=133.32×10⁻⁶ MPa) pressure, for 1.5 hrs. The dried mixture was filtered with a syringe filter (0.2 um). The APHA color number of the poly(trimethylene ether)glycol was found to be at 34.19.

TABLE 1

| Example No. | wt % DOPO added | APHA Value | % Reduction |
|---|---|---|---|
| 1 (comparative) | none | 69.41 | |
| 2 | 1 (hydrolysis) | 24.55 | 65 |
| 3 (comparative) | none | 278.6 | |
| 4 | 0.5 (during drying) | 262.5 | 6 |
| 5 (comparative) | none | 52.0 | |
| 6 | 1 (after drying) | 28.2 | 46 |
| 7 (comparative) | none | 82.6 | |
| 8 | 1 (after drying) | 56.5 | 32 |
| 9 (comparative) | none | 45 | |
| 10 | 1 (after 2^{nd} phase sep) | 34.2 | 24 |

What is claimed is:

1. A process for manufacturing a poly(trimethylene ether)glycol, comprising:
(a) polycondensing reactant comprising a diol selected from the group consisting of 1,3-propanediol, 1,3-propanediol dimer, 1,3-propanediol trimer and mixtures thereof, in the presence of an acid polycondensation catalyst to form a poly(trimethylene ether)glycol and an acid ester of the acid polycondensation catalyst;
(b) adding water to the poly(trimethylene ether)glycol and hydrolyzing the acid ester formed during the polycondensation to form a hydrolyzed aqueous-organic mixture containing poly(trimethylene ether)glycol and residual acid polycondensation catalyst;
(c) forming an aqueous phase and an organic phase from the hydrolyzed aqueous-organic mixture, wherein the organic phase contains poly(trimethylene ether)glycol, residual water and residual acid polycondensation catalyst,
(d) separating the aqueous phase and the organic phase;
(e) optionally adding base to the separated organic phase;
(f) removing residual water from the organic phase; and
(g) if no base has been added to the separated organic phase, optionally separating the organic phase into (i) a liquid phase comprising poly(trimethylene ether)glycol, and (ii) a solid phase comprising salts of the residual acid polycondensation catalyst and unreacted base, and if base has been added to the separated organic phase, separating the organic phase into (i) a liquid phase comprising poly(trimethylene ether)glycol, and (ii) a solid phase comprising salts of the residual acid polycondensation catalyst and unreacted base;
the process comprising adding DOPO at least once during at least one of the steps (b), (c), (d), (e),(f), and (g), such that the total amount of DOPO is from about 0.01 wt % to about 5 wt %, based on the weight of reactant.

2. The process of claim 1, wherein the DOPO is added in a total amount of about 0.03 wt % to about 2 wt %, based on the weight of reactant.

3. The process of claim 1, wherein the poly(trimethylene ether)glycol exhibits an APHA color value at least 5 percent lower than that of a poly(trimethylene ether)glycol product made in the absence of the DOPO.

4. The process of claim 1, wherein the poly(trimethylene ether)glycol exhibits an APHA color value at least 20 percent lower than that of a poly(trimethylene ether)glycol product made in the absence of the DOPO.

5. The process of claim 1, wherein the poly(trimethylene ether)glycol exhibits an APHA color value less than 100.

6. The process of claim 1, wherein the poly(trimethylene ether)glycol exhibits an APHA color value at least 30 percent lower than that of a poly(trimethylene ether)glycol product made in the absence of the DOPO.

7. The process of claim 1, wherein the poly(trimethylene ether)glycol exhibits an APHA color value at least 65 percent lower than that of a poly(trimethylene ether)glycol product made in the absence of the DOPO.

8. The process of claim 1, wherein the time for separating according to step (d) is reduced by 95 percent when compared to the time for separating in the absence of the DOPO.
